(19) United States
(12) Patent Application Publication
(10) Pub. No.: US 2015/0011157 A1
(43) Pub. Date: Jan. 8, 2015

(54) MULTI-AMPLIFIER BOOSTER FOR A WIRELESS COMMUNICATION SYSTEM

(71) Applicant: Wireless Extenders, Inc., Norcross, GA (US)

(72) Inventor: Scott Terry, Norcross, GA (US)

(73) Assignee: Wireless Extenders, Inc., Norcross, GA (US)

(21) Appl. No.: 14/163,566

(22) Filed: Jan. 24, 2014

Related U.S. Application Data
(60) Provisional application No. 61/842,412, filed on Jul. 3, 2013.

(51) Int. Cl. H04B 7/155

(52) U.S. Cl. CPC H04B 7/15535
USPC 455/10

(57) ABSTRACT

A multi-amplifier system includes a remote amplifier located near one or both system antennas. Locating the remote amplifier closer to the antenna improves the system performance while meeting regulatory limitations. The base unit may also have multiple remote antenna ports on one or both sides of the base unit allowing multiple remote antennas to be connected on that side of the base unit. A signal splitter with multiple antenna ports allows multiple remote antennas to be connected on the same side of the base unit. A remote amplifier located near each remote antenna removes the associated signal propagation losses from the regulated system performance. The base unit includes an amplifier detector for each remote antenna port to determine which output ports are connected to remote amplifiers. An automatic gain adjustment unit maintains the system gain, typically at the regulatory gain limit, based on the detected system configuration.

### PRIORITY CLAIM TO RELATED APPLICATION

This application claims priority to commonly-owned U.S. Provisional Patent Application Ser. No. 61/842,412 entitled “Multi-Amplifier Booster System,” filed on Jul. 3, 2013.

### TECHNICAL FIELD

The present invention relates to the field of wireless repeaters also known as boosters for wireless communication devices and, more particularly, to a multi-amplifier wireless booster system with automatic gain control for improving wireless communication service within a building, such as a home or office.

### BACKGROUND

Wireless communication systems have become widely deployed throughout the United States and abroad. A wireless repeater or booster is a radio frequency (RF) device used to amplify wireless communication signals in both uplink and downlink channels. The uplink channel is generally referred to as the direction from a mobile communication device to a base station (also referred to as a tower), while the downlink channel is generally referred to as the direction from the base station to the mobile communication device. The booster typically includes two antennas, a tower-side antenna and a mobile-side antenna, connected by coaxial cables to a base unit that includes a bi-directional amplifier (BDA) that amplifies the wireless communication signals in both directions. In certain frequency bands, the amount of amplification (gain), the maximum output power, the output noise, and other parameters associated with the operation of the booster may be limited to regulatory standards set by the government and industry. These operational limitations are typically measured from the two RF ports on the BDA that feed the coaxial cables that go to the two antennas. Meeting these operational constraints can limit the amplification that the booster is permitted to supply below the operational capability of the booster. Techniques are therefore needed for improving the operational performance of the booster while meeting the regulatory operational constraints.

### SUMMARY OF THE INVENTION

The present invention meets the needs described above in a multi-amplifier booster system that includes a remote amplifier located near one of the system antennas in addition to the bidirectional amplifier included in the base unit. Locating the remote amplifier closer to the antenna improves the system performance while allowing the booster to still meet the regulatory requirements. The base unit may also have multiple remote antenna ports on one side of the base unit allowing multiple remote antennas to be connected on that side of the base unit. A signal splitter with multiple antenna ports allows multiple remote antennas to be connected on the same side of the base unit. A remote amplifier may also be located near each remote antenna to remove the associated signal propagation losses from the regulated system performance. For this configuration, the base unit includes an amplifier detector for each remote antenna port to determine which output ports are connected to remote amplifiers. An automatic gain adjustment unit maintains the system gain, typically at the regulatory gain limit, based on the detected system configuration. The automatic gain adjustment unit typically controls the power at each output port of the base unit independently and may also control the power supplied by each remote amplifier independently.

The booster system may also include multiple antenna ports on both sides of the base unit. In this case, the base unit includes a tower-side splitter feeding multiple tower-side remote antenna ports as well as a mobile-side splitter feeding multiple mobile-side remote antenna ports. The base unit also includes multiple tower-side amplifiers, multiple tower-side amplifier detectors, multiple mobile-side amplifiers, multiple mobile-side amplifier detectors. An automatic gain adjustment unit maintains the gain on a port-by-port basis based on the detected system configuration, which may include both tower-side and mobile-side remote amplifiers. Again for this configuration, the automatic gain adjustment unit typically controls the power at each output port of the base unit independently and may also control the power supplied by each remote amplifier independently. As an option, the uplink and downlink power may also be controlled independently.

In an alternative configuration, the remote amplifier includes an automatic gain adjustment unit that sets the gain to achieve compliance with the output constraint while offsetting the signal propagation losses determined based on test signals received from the base unit. The base unit typically sends the test signal upon detecting the presence of the remote amplifier and the sets the gain supplied to the applicable port to a moderate predetermined value selected for a port connected to the a remote amplifier. This allows the remote amplifier to set its gain based on the base unit setting its gain to the moderate predetermined value.

The specific techniques and structures for implementing particular embodiments of the multi-amplifier booster system, and thereby accomplishing the advantages described above, will become apparent from the following detailed description of the embodiments and the appended drawings and claims.

### BRIEF DESCRIPTION OF THE DRAWINGS

FIG. 1 is a conceptual block diagram showing a prior art booster for a wireless communication system.

FIG. 2 is a conceptual block diagram showing a multi-amplifier booster with one remote amplifier in addition to a base BDA unit.

FIG. 3 is a conceptual block diagram showing both a mobile-side remote amplifier and a tower-side remote amplifier in addition to the base BDA unit.

FIG. 4 is a conceptual block diagram showing a multi-amplifier booster with a signal splitter and multiple remote antennas connected to the same side of the base unit.

FIG. 5 is a conceptual block diagram showing a multi-amplifier booster with two signal splitters and multiple remote amplifiers connected to the both sides of the base unit.

FIG. 6 is a conceptual block diagram showing an alternative multi-amplifier booster having one or more remote amplifiers with automatic gain adjustment.

FIG. 7 is a logic flow diagram for operating a base unit in a wireless repeater system with one or more remote amplifiers with automatic gain adjustment.

FIG. 8 is a logic flow diagram for operating a remote amplifier with gain adjustment in a wireless repeater system.

### DETAILED DESCRIPTION OF THE EMBODIMENTS

Embodiments of the invention may be realized in multi-amplifier systems that include a remote amplifier located near one of the system antennas in addition to the bidirectional amplifier included in the base unit. Locating the remote amplifier closer to its respective antenna moves the RF port used to determine applicable regulatory constraints closer to the antenna. The regulatory constraints are therefore applied to the power at the remote amplifier RF output port, rather than the base unit RF output port. This effectively removes the signal propagation losses between the base unit and the remote amplifier from the limitation on booster performance caused by compliance with the regulatory constraints. The permissible power experienced at the antenna is therefore increased by the signal propagation losses between the base unit and the remote amplifier, while the booster system continues to meet the same regulatory constraints.

In a booster system utilizing a remote amplifier in addition to the base unit, the remote amplifier may be located near either the tower-side antenna or the mobile-side antenna, as desired for a particular application. Typically the remote amplifier should be positioned to remove the longest run of coaxial cable from the performance limitation. The same technique may also be utilized for both antennas resulting in a repeater system with three amplifiers: the base unit amplifier, a tower-side remote amplifier, and a mobile-side remote amplifier.

The base unit may also have multiple remote antenna ports on one side of the base unit allowing multiple remote antennas to be connected on that side of the base unit. For example, the booster system may include multiple tower-side antenna ports to allow multiple tower-side antennas to be connected to improve base station reception. As another option, the base unit may include multiple mobile-side remote ports allowing multiple mobile-side remote antennas to be connected to provide improved cellular telephone reception in multiple locations within the customer premises. To accommodate this option, the base unit includes a signal splitter with multiple antenna ports allowing multiple remote antennas to be connected on the same side of the base unit. Remote antennas may be connected to any number of the available ports. A remote amplifier may be located near one or more of the remote antenna to remove the associated signal propagation losses from the regulated system performance. The permissible gain supplied by booster system varies depending on which output ports are connected to remote amplifiers. The base unit therefore includes an amplifier detector for each remote antenna port to determine which output ports are connected to remote amplifiers. An automatic gain adjustment unit maintains the system gain, typically at the regulatory gain limit, based on the detected system configuration.

In another embodiment, the booster system may include multiple antenna ports on both sides of the base unit. In this case, the base unit includes a tower-side splitter feeding multiple tower-side remote antenna ports as well as a mobile-side splitter feeding multiple mobile-side remote antenna ports. The base unit also includes multiple tower-side amplifier detectors, multiple mobile-side amplifier detectors, and an automatic gain adjustment unit to maintain the system gain based on the detected system configuration, which may include multiple tower-side and multiple mobile-side remote amplifiers.

In the configurations described above where the automatic gain adjustment unit resides in the base unit, the base unit utilizes a predetermined signal propagation loss estimate for each remote amplifier detected. For example, the predetermined signal propagation loss estimate typically corresponds to the power losses experienced by the standard length cable that comes with the unit, such as a 25 foot length of 75 Ohm cable. However, some users may connect longer lengths of cable, for example when connecting a roof-mounted antenna to a base unit located in a basement. A typical base unit may be configured to support cable lengths up to 75 or 100 feet. In this case, the base unit may not be configured to adjust its gain to compensate for the full amount of signal loss occurring on the longer lengths of cable. It should be noted that this approach has the advantage of simplicity in that loss measurements are not necessary and the system only requires automatic gain adjustment capability in the base unit. But there is still room for improvement through additional functionality.

In particular, adding the ability to measure the actual power loss and adjust the gain accordingly provides for additional gain improvement, particularly when different lengths of cable are used to connect the remote amplifiers. An alternative configuration therefore includes one or more remote amplifiers that measure the power loss based on test signals generated by the base unit and automatically adjust their gain based on the measured signal propagation losses. As this approach may be implemented in repeaters systems with multiple remote amplifiers on the tower side, the mobile side, or both, the base unit detects the presence of remote amplifiers and implements automatic gain adjustment on a port-by-port basis.

While a DC test signal provides a good estimate of the signal losses at the RF operating frequency, the base unit may transmit an RF test signal instead of or in addition to a DC test signal. The base unit detects the presence of each remote amplifier and adjusts the gain on those ports to a moderate predetermined value for ports connected to remote amplifiers. The remote amplifier correspondingly adjusts its gain to maximum permissible level based on the assumption that the base unit gain will be set to the moderate predetermined value for ports connected to remote amplifiers. As opposed to maximizing the gain applied by the base unit, this approach reduces power losses by moderating the power transmitted over the long length of cable between the base unit and the remote amplifier.

Typically, each remote unit is configured to enter into a gain initialization mode, await test signals, and set its gain upon power up. The base unit may therefore be correspondingly configured to transmit test signals to a detected remote upon detecting the presence or powering up of the remote. Upon restart, reset, change in port status, cable connection, or any other desired condition the base unit may also be configured to ping its ports followed transmission of the test signals to cause the remote amplifiers to reinitialize their gain settings. It should be appreciated that gain adjustment protocol described above does not require the transmission of port address or any encoded information between the base unit and the remote amplifiers.

In all embodiments, the remote amplifier effectively removes the power losses on an associated coaxial cable from the power reduction experienced at an associated antenna caused by complying with the regulatory constraints. In any instance where a remote amplifier is utilized, the remote amplifier and its associated antenna may be, but does not necessarily have to be, configured as an integrated antenna/amplifier unit to further reduce the amount of coaxial cable in the system and simplify the installation. The base unit typically controls the power supplied to port independently. As a result, the gain applied in the uplink and downlink channels may be controlled independently on a port-by-port basis based on the presumed or measured signal propagation losses between the base unit and each remote amplifier.

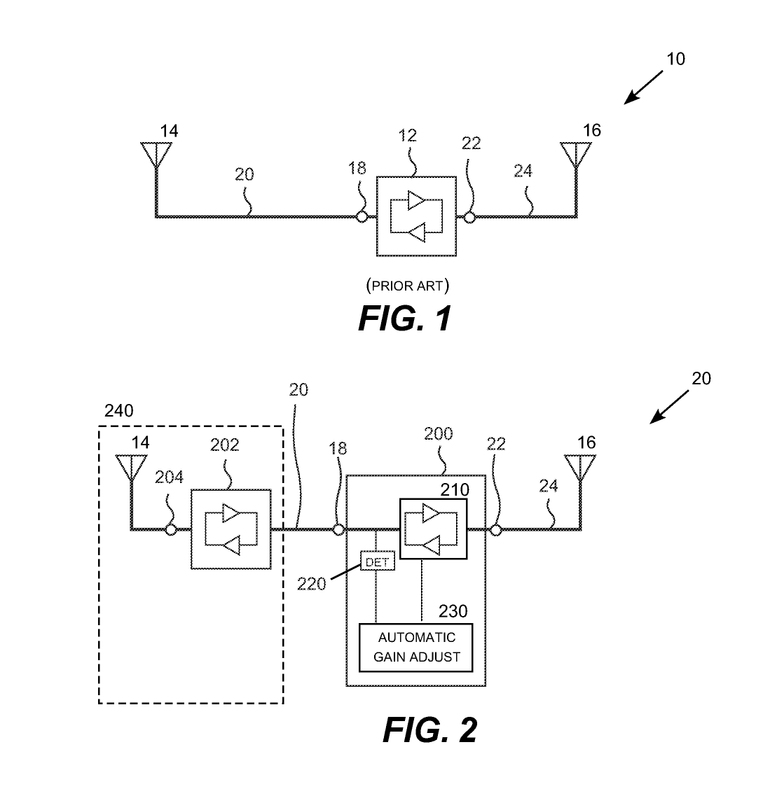

Turning now to the drawings, in which like numerals refer to like elements throughout the several figures, FIG. 1 is a conceptual block diagram showing a prior art booster 10 for a wireless communication system. The system includes a base unit 12 housing a bi-directional antenna (BDA), a tower-side antenna 14, and a mobile-side antenna 16. It will be appreciated that any functionality shown or described for the tower-side antenna may be the mobile-side antenna and vice versa. The base unit 12 has a tower-side radio frequency (RF) output port 18 and a tower-side coaxial cable 20 connecting the output port 18 to the tower-side antenna 14. Similarly, the base unit has a mobile-side RF output port 22 and a mobile-side coaxial cable 24 connecting the output port 22 to the mobile-side antenna 16. Certain regulatory constraints (e.g., output power, output noise, signal to noise ratio, etc.) applicable to the booster system 10 are determined by rule using the parameters experienced at the amplifier RF output ports 18, 22.

The specific regulatory constraints are typically met by limiting the amplification (gain) supplied by the BDA to ensure that all of the applicable constraints are satisfied. This directly limits the power available at the RF output ports 18, 22, which in turn limits the power available at the antennas 14, 16. Since the system experiences power propagation losses over the coaxial cables 20, 24, the power available at the antennas 14, 16 is reduced from the power available at the RF output ports 18, 22. These propagation losses can be significant, for example when a long run of coaxial cable is utilized to connect a roof-mounted tower-side antenna with a base unit located within the customer premises. Propagation losses can also be significant on the mobile side, for example where the base unit is located in an attic where cable access to the tower-side antenna is available and a long a long run of coaxial cable is utilized to connect the base unit to a mobile-side location in a basement office where improved wireless reception is desired. Connection guidelines typically allow on the about 75 to 100 feet of 75Ω coaxial cable on each side of the base unit. As the maximum allowable cable runs are based on the maximum tolerable signal propagation losses, those losses can be quite significant when the installation involves anywhere near the maximum allowable cable runs.

FIG. 2 is a conceptual block diagram in which the booster of FIG. 1 has been expanded into a multi-amplifier booster 20 that includes a remote tower-side amplifier 202 located near the tower-side antenna 14. The remote tower-side amplifier 202 includes an RF port 204 where the tower-side antenna 14 connects to the remote tower-side amplifier. As an option, the remote tower-side amplifier 202 and the tower-side antenna 14 may be deployed as an integrated amplifier/antenna unit 240. The base unit 200 includes a BDA 210, a mobile-side RF port 18, a remote amplifier detector 220, and an automatic gain adjustment unit 230. The remote amplifier detector 220 detects the presence of the remote tower-side amplifier 202 connected to the coaxial cable 20, typically by detecting a change in impedance caused by the presence of the amplifier. The automatic gain adjustment unit 230 receives a remote amplifier detection signal from the detector 220 and adjusts the gain of the BDA 210 to set the gain of the BDA to a maximum level that meets the applicable regulatory operational constraints using the RF ports 22 and 204 in the applicable determinations. The automatic gain adjustment unit 230 may adjust the gain of the BDA 210, the BDA 202, or both as desired. This moves the location of the power measurement used for determining compliance with the applicable regulatory constraints on the tower side of the booster from the location of the base unit port 18 to the location of the remote amplifier port 204.

In the booster 20, the remote amplifier 202 is located closer to the tower-side antenna 14 than in the prior art configuration shown in FIG. 1. This moves the RF port 204 used to determine compliance with the regulatory constraints closer to the tower-side antenna 14 that in the conventional booster 10. The regulatory constraints are therefore applied to the power at the remote amplifier RF port 204 in the booster 20, rather than the base unit RF port 18 in the conventional booster 10. This effectively removes the signal propagation losses on the coaxial cable 20 between the base unit 200 and the remote tower-side amplifier 202 from the power reduction experienced at the tower-side antenna 14 caused by compliance with the regulatory constraints. In comparison to the conventional booster 10, the power experienced at the tower-side antenna 14 in the booster 20 is therefore increased by the signal propagation losses on the coaxial cable 20, while the booster 20 continues to meet the same regulatory constraints. In other words, the propagation losses experienced on the coaxial cable 20 have been effectively removed from the booster performance limitation caused by compliance with the regulatory constraints.

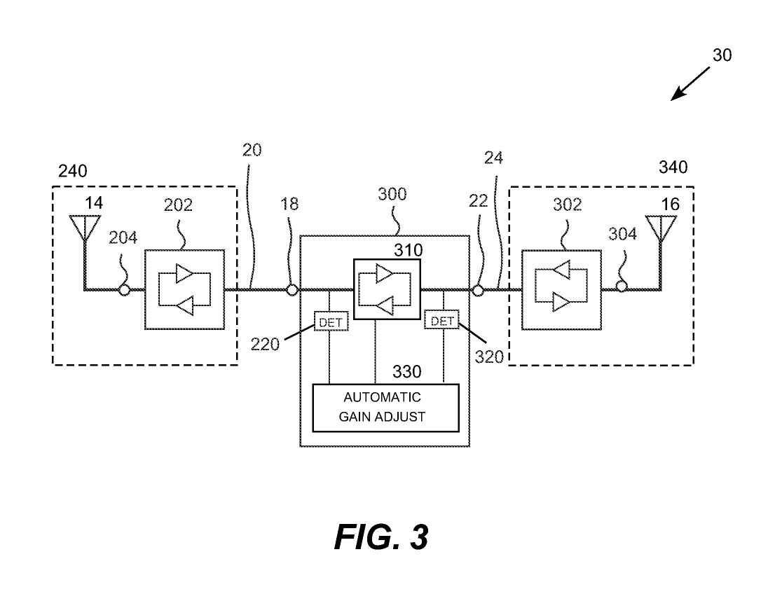

In a booster system utilizing one remote amplifier in addition to the base unit, the remote amplifier may be located near either the tower-side antenna or the mobile-side antenna, as desired for a particular application. Typically the remote amplifier should be positioned to remove the longest run of coaxial cable from the performance limitation. In addition, as shown in FIG. 3, the same technique may also be utilized for both antennas. FIG. 3 is a block diagram in which the booster of FIG. 2 has been further expanded into a repeater system 30 with three amplifiers: the base unit amplifier 300, the tower-side remote amplifier 202 located near the tower-side antenna 14, and a mobile-side remote amplifier 302 located near the mobile-side antenna 16. The remote mobile-side amplifier 302 includes an RF port 304 where the mobile-side antenna 16 connects to the remote mobile-side amplifier 302. The mobile-side remote amplifier 302 and the mobile-side antenna 16 may be configured as an integrated antenna/amplifier unit 340 to further reduce the amount of coaxial cable in the system. The remote amplifier detector 320 detects the presence of the remote mobile-side amplifier 302 connected to the coaxial cable 24, typically by detecting a change in impedance caused by the presence of the amplifier. The automatic gain adjustment unit 330 receives a remote amplifier detection signal from the detectors 220 and 320 and adjusts the gain of the BDA 310 to set the gain to a maximum level that meets the applicable regulatory operational limits using the RF ports 204 and 304 in the applicable determinations. The automatic gain adjustment unit 330 typically adjusts the power to the output ports 18 and 22 independently and may also adjust the gain of the BDAs 202 and 302 independently. The uplink gain and the downlink gain may also be controlled independently to optimize the performance of the booster while satisfying all applicable regulatory constraints.

In the booster 30 shown in FIG. 3, the remote mobile-side amplifier 302 is located closer to the mobile-side antenna 16 than in the configuration shown in FIG. 2. This moves the RF port 304 used to determine compliance with the regulatory constraints closer to the mobile-side antenna 16 than in the configuration shown in FIG. 2. The regulatory constraints are therefore applied to the power at the remote amplifier RF ports 204 and 304 in the booster 30, which effectively removes the signal propagation losses on both coaxial cables 20, 24 from the limitation on booster performance caused by compliance with the regulatory constraints. In comparison to the configuration shown in FIG. 2, the power experienced at the mobile-side antenna 16 in the booster 30 is therefore increased by the signal propagation losses on the coaxial cable 24, while the booster 30 continues to meet the same regulatory constraints.

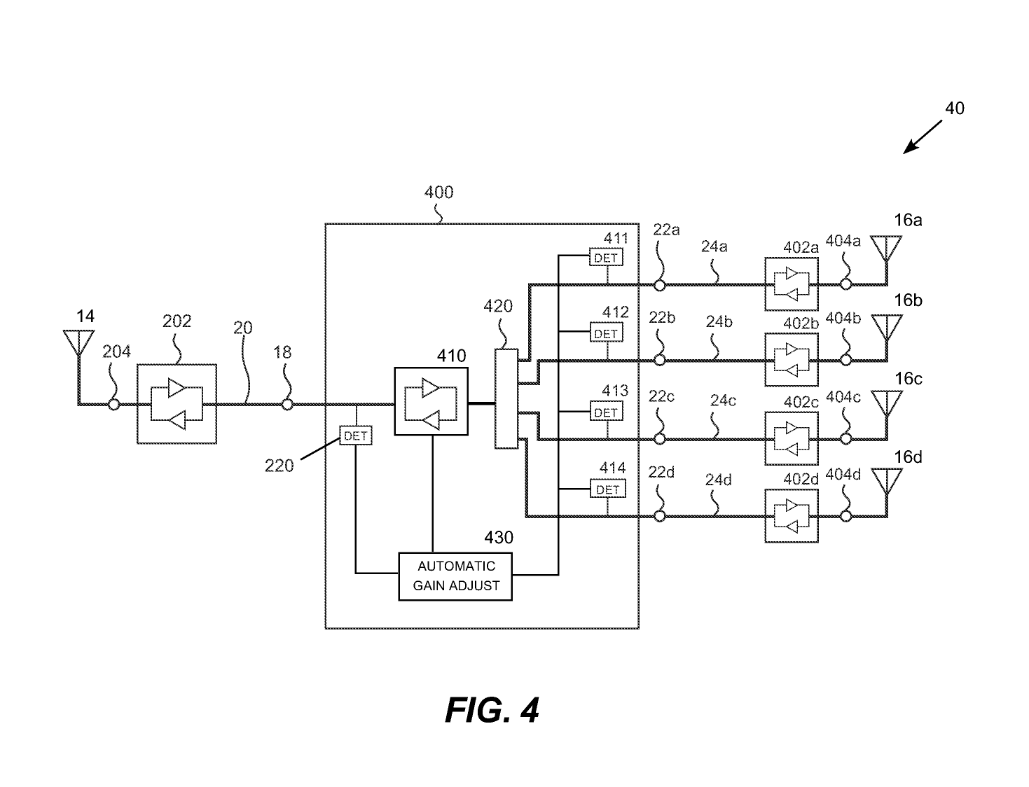

FIG. 4 is a block diagram in which the booster of FIG. 3 has been further expanded into a repeater system 40 with a signal splitter 420 and multiple remote antennas 16a-16d connected to the mobile side of the base unit 400. The base unit also includes multiple mobile-side amplifiers 402a-402d connected to respective remote antenna ports 22a-22d on the mobile side of the base unit 400. The coaxial cables 24a-24d connect the remote antenna ports 22a-22d to the respective mobile-side amplifier 402a-402d. To accommodate this option, the base unit 400 includes the signal splitter 420, which divides the mobile-side output of the BDA 410 into separate channels for the multiple antenna ports. Each remote amplifier is typically located near, and may be integral with, its respective remote mobile-side antenna to remove the associated signal propagation losses from the regulated system performance.

In this configuration, the permissible gain supplied by booster system 40 varies depending which output ports 22a-22d are connected to remote amplifiers. The base unit 400 therefore includes amplifier detectors 411, 412, 413 and 414, with one detector for each remote antenna port 22a-22d to determine the output ports that are connected to remote amplifiers on the mobile side of the base unit. The automatic gain adjustment unit 430 maintains the system gain, typically at the regulatory gain limit, based on the detected system configuration. The automatic gain adjustment unit 430 typically controls the gain supplied by the base BDA 410 to each port 402a-402d independently. The automatic gain adjustment unit 430 may also control the gain supplied by each remote mobile-side amplifier 402a-402d independently. The uplink gain and the downlink gain may also be controlled independently.

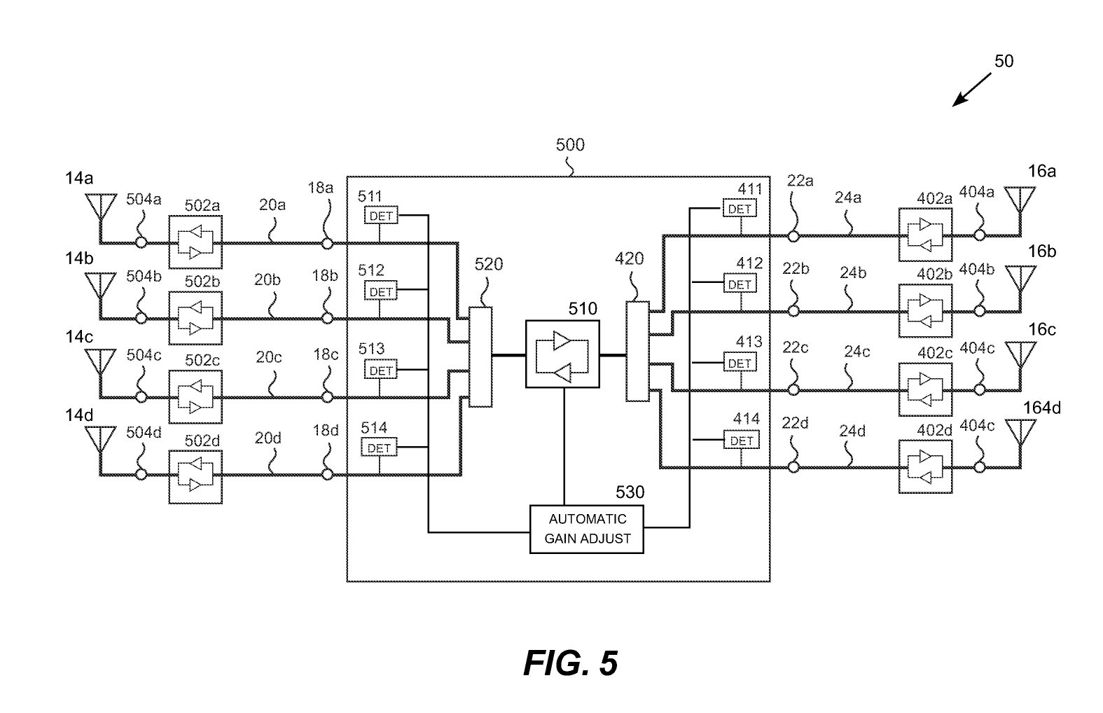

FIG. 5 is a block diagram in which the booster of FIG. 4 has been further expanded into a repeater system 50 with a second signal splitter 520 and multiple remote antennas 14a-d connected to the tower side of the base unit 500. The base unit also includes multiple tower-side amplifiers 502a-502d connected to respective remote antenna ports 18a-18d on the tower side of the base unit 500. Coaxial cables 20a-20d connect the remote antenna ports 18a-18d to respective tower-side amplifiers 502a-502d. To accommodate this option, in addition to the mobile-side splitter 420, the base unit 500 includes the tower-side splitter 520 dividing the tower-side output of the BDA 510 into separate channels for the multiple tower-side antenna ports. Again, each remote tower-side amplifier is typically located near, and may be integral with, its respective remote tower-side antenna to remove the associated signal propagation losses from the regulated system performance. In this embodiment, the permissible gain supplied by booster system 50 varies depending which output ports 18a-18d are connected to remote amplifiers. The base unit 500 therefore includes amplifier detectors 511, 512, 513 and 514, with one detector for each remote tower-side antenna port 18a-d to determine which output ports are connected to remote amplifiers connected on the tower side of the base unit. The automatic gain adjustment unit 530 maintains the system gain, typically at the regulatory gain limit, based on the detected system configuration. The propagation losses experienced on the coaxial cables 24a-d and 20a-20d are effectively removed from the booster performance limitation while the detectors 411-414 and 511-514 allow the automatic gain adjustment unit 530 to dynamically adjust the gain of the BDA 510 based on the number of mobile-side amplifiers and tower-side amplifiers actually connected to the system 50. The automatic gain adjustment unit 530 typically controls the gain supplied to each tower-side port 18a-18d and each mobile-side port 22a-22d independently. The automatic gain adjustment unit 530 may also control the gain supplied by each remote mobile-side amplifier 402a-402d and each remote tower-side amplifier 502a-502d. The uplink gain and the downlink gain may also be controlled independently.

In the configurations described with reference to FIGS. 1-5, the automatic gain adjustment unit resides in the base unit and there is no mechanism established for measuring the actual power losses on the cables between the base unit and the remote amplifiers. The base unit therefore utilizes a predetermined signal propagation loss estimate for each remote amplifier such as the losses on a standard 25 foot length of 75 Ohm cable, which may not be accurate for significantly longer lengths of cable. A typical base unit is configured to support cable lengths up to 75 to 100 feet which allows users to connect cables significantly longer than the standard 25 foot cable, as desired. When this occurs, a base unit that utilizes power loss estimates based on the standard 25 foot cable will not be configured to adjust its gain to compensate for the full amount of signal loss occurring on the longer cables.

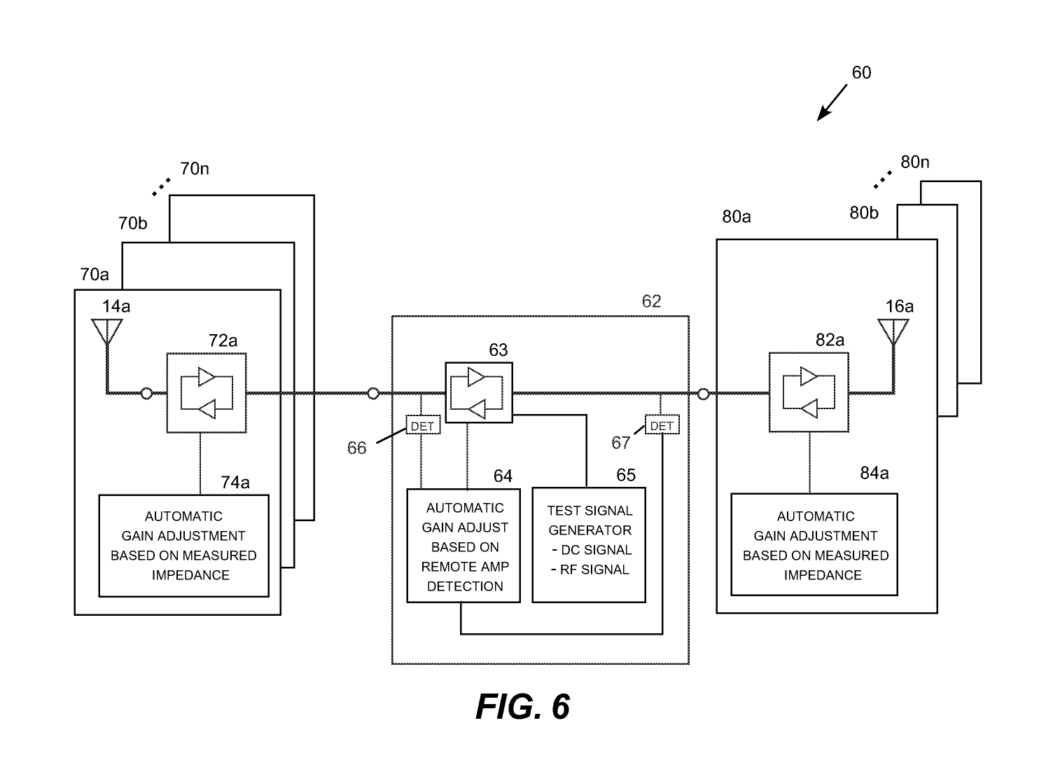

FIG. 6 is a conceptual block diagram showing an alternative multi-amplifier booster system 60 having one or more remote amplifiers 70a-n, 80a-n with automatic gain adjustment operative to measure the actual signal propagation losses and set their gain accordingly. Adding the ability of the remote amplifier to measure the actual power loss and adjust its gain to achieve compliance with the regulatory standard while offsetting the measured signal loss provides for additional gain improvement. It should be appreciated that this automatic gain adjustment technique is independent of the number of remote amplifiers connected to the base unit and may therefore be implemented on a port-by-port basis by any number of remote amplifiers. Although the base unit need not include an automatic gain adjustment unit, additional gain improvement is achieved when the base unit and the remote amplifiers include automatic gain adjustment units that are configured to operate cooperatively.

The repeater system 60 includes a base unit 62 that includes a bidirectional amplifier 63 operative to control the gain applied to one or more tower-side ports and one or more mobile-side ports on a port-by-port basis. In this particular system, the base unit also includes a gain adjustment unit 64 that adjusts the gain applied on a port-by-port basis in response to remote amplifier detection. A test signal generator 65 generates test signals at a precisely maintained test voltage and current levels that each remote amplifier measures to determine the signal propagation losses occurring on the cable between the base unit and the respective remote amplifier. The test signals typically include a DC signal and may alternatively or in addition include a test signal at the operating RF frequency suitable for determining the cable impedance and associated signal propagation losses.

A representative remote amplifier 70a includes an antenna 14a, a bidirectional amplifier 72a, and an automatic gain adjustment unit 74a. The remote amplifier determines the signal propagation losses based on the test signals received from the base unit and sets its gain accordingly, typically to the maximum level permitted by the governing regulations. In order to further reduce the signal propagation losses, the base unit is configured to set the gain supplied to a port connected to a remote amplifier connected to a moderate predetermined value. The remote amplifier is likewise configured to set its gain based on the presumption that the base unit will set its gain to the moderate predetermined value for a port connected to a remote amplifier. As opposed to maximizing the gain applied by the base unit 62, this approach reduces power losses by moderating the power transmitted over the long length of cable between the base unit and the remote amplifier 70a.

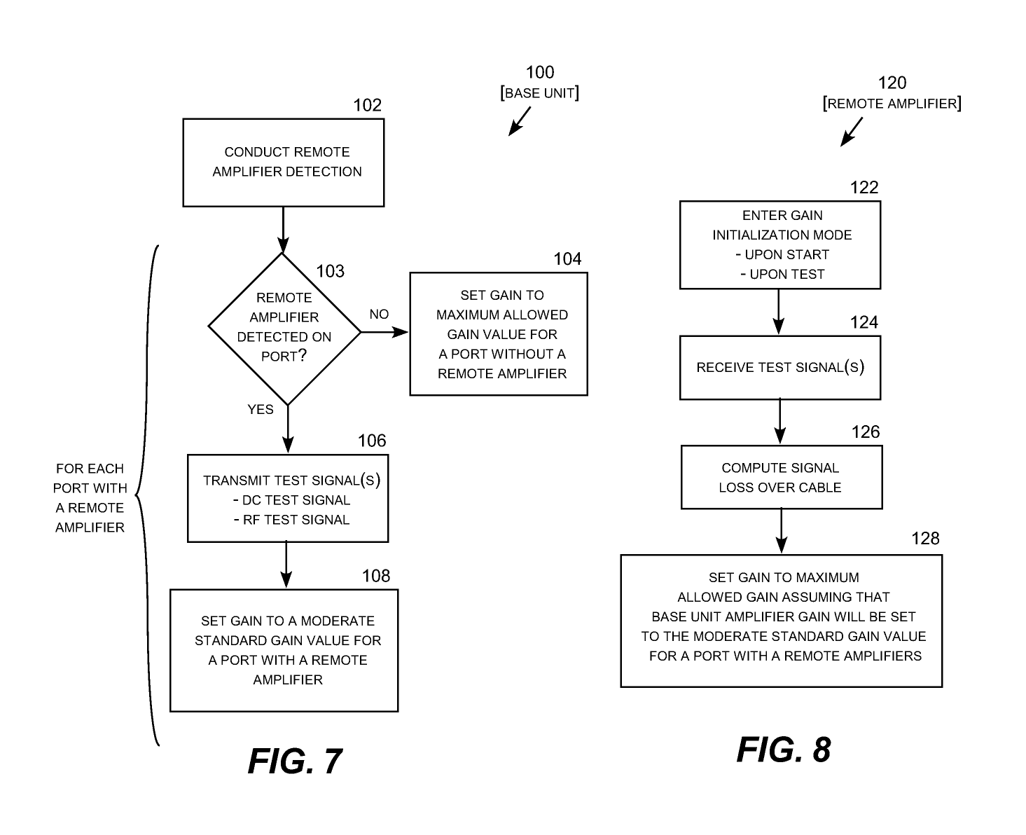

FIG. 7 is a logic flow diagram illustrating a routine 100 for operating the base unit 62. In step 102, the base unit conducts remote amplifier detection, for example by detecting a change in impedance or voltage that inherently occurs on the port whenever a remote amplifier is connected. Alternatively, the remote amplifier may be configured to transmit an initiation signal upon connection or powering up. The base unit may also be configured to send inquiries to its ports (scan for remotes) that the remotes respond to. For example, the base unit may scan for remotes whenever the base unit powers up, experiences a reset, to detect a change in an electrical parameter the voltage or impedance connected to a port.

Step 102 is followed by step 103, in which the base unit determines whether a remote amplifier has been detected on a particular port. If a remote amplifier is not detected, the “no” branch is followed to step 104 in which the base unit sets the gain on the port to the regulatory maximum for a port without a remote amplifier. Typically the base unit sets the gain for a port without a remote amplifier to offset signal propagation losses over a standard length cable, such as a 25 foot length of cable. If a remote amplifier is detected, the “yes” branch is followed to step 106 in which the base unit transmits on or more test signals over the port in accordance with the established test protocol. Step 106 is followed by step 108, in which the base unit sets the gain on the port to a moderate predetermined value for a port connected to a remote amplifier. Steps 103-108 are typically performed on a port-by-port basis for each remote amplifier connected to the base unit. It will be appreciated that this routine does not require that the base unit communicate any information other than a previously established test signal to the remote amplifier. In addition, the base unit is operative to detect the presence of the remote amplifier without receiving encoded information from the remote. As a result, there is no need for an addressing scheme, handshake or exchange of encoded information required to implement the gain control procedure.

FIG. 8 is a logic flow diagram for a routine 120 for operating the remote amplifier 70a. In step 122, the remote amplifier enters into a gain initialization mode, for example upon powering up, restart or in response to a test signal received from the base unit. Step 122 is followed by step 124, in which the remote amplifier receives the predefined test signal(s) from the base unit. Step 124 is followed by step 126, in which the remote amplifier computes the signal propagation losses over the cable between the base unit and the remote amplifier. The cable impedance may also be determined from the voltage drop caused by the test current. Step 126 is followed by step 128, in which the remote amplifier sets its gain to the desired level based on the measured signal propagation losses. In particular, the remote amplifier gain is typically set to maximum value permitted by regulation given that the base unit gain is programmed to set its gain to the moderate predetermined value established for a port connected to a remote amplifier.

It should be understood that the foregoing relates only to the exemplary embodiments of the present invention, and that numerous changes may be made therein without departing from the spirit and scope of the invention as defined by the following claims.

The invention claimed is:

1. A wireless repeater comprising:
a first antenna;
a second antenna;
a first remote amplifier connected to the first antenna;
a base unit configured to supply amplified wireless communication signals to the first and second antennas in uplink and downlink channels, the base unit comprising a bidirectional amplifier having one or more output ports;
a first cable connecting a first output port of the base unit to the first remote amplifier;
the base unit further comprising a first detector operative for detecting the connection of the first remote amplifier to the first output port;
the base unit further comprising an automatic gain adjustment unit operative for adjusting a first gain supplied to the first output port to achieve compliance with an output constraint while offsetting expected signal propagation losses on the first cable.

2. The wireless repeater of claim 1, wherein the first antenna is a tower-side antenna and the second antenna is a mobile-side antenna.

3. The wireless repeater of claim 1, wherein the first antenna is a mobile-side antenna and the second antenna is a tower-side antenna.

4. The wireless repeater of claim 1, wherein the base unit is further operative for setting gains supplied to multiple tower-side ports to offset expected signal losses on multiple cables connected to multiple tower-side remote amplifiers.

5. The wireless repeater of claim 1, wherein the base unit is further operative for setting gains supplied to multiple mobile-side ports to offset expected signal losses on multiple cables connected to multiple mobile-side remote amplifiers.

6. The wireless repeater of claim 1, wherein the expected signal losses on the first cable are based on a standard length of cable expected to be connected between the remote amplifier and the first output port.

7. The wireless repeater of claim 1, wherein the output constraint is based on a regulatory standard.

8. The wireless repeater of claim 1, further comprising:
a second remote amplifier connected to the second remote antenna;
a second cable connecting a second output port of the base unit to the second remote amplifier;
the base unit further comprising a second detector operative for detecting the connection of the second remote amplifier to the second output port;
wherein the base unit automatic gain adjustment unit is further operative for adjusting a second gain supplied to the second output port to achieve compliance with the output constraint while offsetting expected signal losses on the second cable.

9. The wireless repeater of claim 8, wherein the base unit is further operative for setting gains supplied to multiple tower-side ports to offset expected signal losses on multiple cables connected to multiple tower-side remote amplifiers.

10. The wireless repeater of claim 8, wherein the base unit is further operative for setting gains supplied to multiple mobile-side ports to offset expected signal losses on multiple cables connected to multiple mobile-side remote amplifiers.

11. The wireless repeater of claim 8, wherein the base unit is further operative for setting gains supplied to multiple tower-side ports to offset expected signal losses on multiple cables connected to multiple tower-side remote amplifiers, and for setting gains supplied to multiple mobile-side ports to offset expected signal losses on multiple cables connected to multiple mobile-side remote amplifiers.

12. The wireless repeater of claim 1, wherein the test signal comprises a DC test signal.

13. The wireless repeater of claim 1, wherein the test signal comprises an RF test signal at an operational frequency of the wireless repeater.

14. A wireless repeater comprising:
a first antenna;
a second antenna;
a remote amplifier connected to the first antenna;
a base unit configured to supply amplified wireless communication signals to the first and second antennas in uplink and downlink channels, the base unit comprising a base unit bidirectional amplifier having one or more output ports;
a cable connecting a first output port of the base unit to the remote amplifier;
the base unit operative for transmitting a test signal to the remote amplifier;
the remote amplifier comprising an automatic gain adjustment unit operative for determining signal propagation losses on the cable based on the test signal and adjusting a gain supplied to the first antenna to achieve compliance with an output constraint while offsetting the signal propagation losses.

15. The wireless repeater of claim 14, wherein:
the base unit further comprises a detector operative for detecting the connection of the remote amplifier to the first output port;
the base unit further comprises an automatic gain adjustment unit operative for responding to the detection of the remote amplifier by setting a gain supplied to the first output port to a predetermined moderate value for a port connected to a remote amplifier;
the remote amplifier is further operative for setting its gain based on the base unit gain supplied to the remote amplifier being set to the predetermined moderate value for a port connected to a remote amplifier.

16. The wireless repeater of claim 15, wherein the base unit is further operative for transmitting the test signal on the first output port in response to detecting the connection of the remote amplifier to the first output port.

17. The wireless repeater of claim 15, further comprising multiple tower-side remote amplifiers that are each connected to the base unit and operative for determining signal propagation losses based a test signal received from the base unit and adjusting a gain supplied to an associated antenna to achieve compliance with an output constraint while offsetting the signal propagation losses.

18. The wireless repeater of claim 15, further comprising multiple mobile-side remote amplifiers that are each connected to the base unit and operative for determining signal propagation losses based a test signal received from the base unit and adjusting a gain supplied to an associated antenna to achieve compliance with an output constraint while offsetting the signal propagation losses.

19. The wireless repeater of claim 15, wherein the test signal comprises a DC test signal.

20. The wireless repeater of claim 15, wherein the test signal comprises an RF test signal at an operational frequency of the wireless repeater.
